(19) United States
(12) Patent Application Publication
(10) Pub. No.: US 2002/0153726 A1
(43) Pub. Date: Oct. 24, 2002

(54) Emergency mobile-to stationary electric power plant

(76) Inventor: Maurice N. Sumner, Houston, TX (US)

Correspondence Address: Maurice N. Sumner, 415 W. Pierce St., Houston, TX, 77019, US

(21) Appl. No.: 09/836,975

(22) Filed: Apr. 18, 2001

(51) Int. Cl. H02P 9/00

(52) U.S. Cl. 290/1 A

(57) ABSTRACT

A mobile electric power plant for quick emergency deployment with quickness gained by pre-engineering to minimize permanent construction and its associated rules, rulings, hearings, controls, and permits, the whole comprising a hybrid vehicle such as a diesel-electric locomotive or truck adapted to rapid and economical reversible conversion to stationary power supply by power conversion gear and self-erecting transmission line and foundation means and by environmentally correct fueling.

### BACKGROUND OF THE INVENTION AND THE PRIOR ART

California recently has had rolling blackouts and power outages with disastrous consequences for health, convenience, and earnings, due to ill-considered legislation, attitudes, and practices. California has required power companies to supply power at a fixed price while preventing the same companies from contracting to buy power for a fixed price. Such laws, attitudes and practices have led to deterioration of electrical infrastructure in all of fuel supply, hydroelectric reserves, power-generation, and power-transmission lines. Other related facts of business in California include strict requirements on construction and complex, time-consuming and burdensome restraints and permitting associated therewith. Recent events may lead to improvements, but improvements will take a long time, and in the mean time there is a need for emergency power and for avoidance of the delays associated with construction of infrastructure.

Some people and companies have recently obtained their own emergency power plants, all the way from little Honda package generators for keeping the food cold in the refrigerator to full-blown power plants on a building site, just as many hospitals, office buildings and industrial plants have always done, but the delays, the first investment, the devotion of building resources and site space, of construction of such plants all are burdensome. Having bought and installed a power plant, little of its value will be recoverable after the need has gone away.

Portable generators are ubiquitous, all the way from the little motor-generators in the back of a pickup truck for use of job-site carpentry saws up to enormous multi-megawatt barge-mounted power plants, at least one of which was made in Japan and floated across the Pacific to serve as the power plant for a city and associated agricultural complex in Brazil. Jackup barges used for oil exploration and production offshore comprise large power plants, as do ships. However, all of these require infrastructure construction for safe service to land facilities.

A particular type of portable motor-generator is the hybrid automobile, truck, and diesel-electric railway locomotive. Such cars are now offered by Honda and Toyota, such a truck is being developed by Lockheed-Martin and the U.S. Army National Automotive center, and the locomotive is ubiquitous. The power generated is for motivation of the vehicle, although it serves other ancillary purposes of the vehicle, such as headlights, horns, and large and small accessories, and the vehicles are not seen as being motor-generators in the usual sense.

Packaged power plants such as are used by hospitals and stores to continue essential services during outages are well-known, but emergency provision of such a plant power plant for use by a food-processing or manufacturing plant involve all of the difficulties of new construction including especially delay and the taking up of space. Commonly the service entrance would be obstructed by such things as fireplugs and ancillary structures, so often even the placement of a portable plant in the yard would involve new construction, or exposure to the hazard of a jury rig.

### BRIEF SUMMARY OF THE INVENTION

The invention comprises a hybrid vehicle, i.e. a vehicle having a heat engine driving an electrical generator which produces motive power for the vehicle, said vehicle being converted to a site-stationary emergency power plant by incorporation of power conversion apparatus including switch gear and a transformer or an inverter, and inclusion of self-erecting transmission-line means and protective switch-gear for introducing the emergency power to the site. Also included for some embodiments are walking foundation means such as walking jacks or caterpillar tracks. A notable feature of the invention is the pre-engineering and pre-qualification of major parts under various codes so as to enable immediate temporary emergency stationary establishment without the expense and delay of site construction and permits except for the uncontroversial electrical service entry and switch.

### THE OBJECT OF THE INVENTION

The main object of the invention is to protect and improve the health, comfort, habitat, safety, and livelihood of people living where electric power is in short supply and in a time of troubles, largely by utilization of existing motor-generator capacity found in existing hybrid vehicles, thereby saving the people and the institutions of an area the burden of large and unrecoverable fixed investment made to get through a time of troubles which will end and, ending, thereupon obviate the continuation of need for the said investment. In particular, there are diesel-electric locomotives all across the country which can be mobilized very quickly and at low cost to meet these purposes as taught herein, since the ancillary power adaptation and transmission means of the invention cost only a fraction of what the standby diesel-electric skid-mounted motor-generators and accessories of installed systems costs, and since, even if the ancillary means were discarded they would cost about the same in money as and much less in time than their fixed-system counterparts of the prior art, but they would not be discarded, because they would be much more salvageable or re-usable elsewhere than fixed-installation such means, partly because they are on wheels. Another object of the invention is to save time and money in installation of auxiliary power supply by saving the time and troble associated with fixed construction an of removal of fixed construction, both of which require permits. Another object is to provide a new source of income to railroads having idle engines and utilities having idle pole trucks, and a related object is to provide relief from railway labor contract requirements of crew-member rank and crew size for stationary locomotive engines by removing the engines from the railway. Another object of the invention is to provide political subdivisions bargaining power and negotiating slack that they might not otherwise have by increasing alternatives. Another object is to provide a market for coal with attendant conservation of natural gas and other fluid fuels. Another object is to give military hybrid trucks the means to give AC power to facilities damaged in war. Another object is to provide rapid transmission-line installation and removal for emergencies.

### BRIEF DESCRIPTION OF THE DRAWINGS

FIG. 1 shows diesel-electric locomotive 1 having removable tap means 2 connecting the generator of locomotive 1 to hookup means 3. Car 4 carries spool means 5 and knuckle-boom crane 6. Attached to and behind car 4 is car 7, car 7 being a diesel-fuel-carrying tank car carrying hose and pumping means 8 having jackup legs 8a thereon. The whole is shown broadside in travelling array disposed along track 9 in FIG. 1.

FIG. 2 shows car 4 in end view and parked on track 9 deployed to give emergency service to building 10 through weatherhead 11a and through pre-existing transformer 12 on pre-existing pole 13. Means 5 seen before, but not shown in this Fig., feeds cable 14 through emergency switch gear 15, set by the utility company on transformer 12 for this emergency, into transformer 12. The means 5 feeds line to crane 6 which then carries said 14 on insulators 6a of crane 6 and insulators 17a of knuckle-boom crane 17 on truck 16 to support line 14 over the distance.

FIG. 3 shows truck 16 just seen with crane 17 and means 17a, 17b folded, with truck 16 modified by the addition and installation of the inverter means 18.

FIG. 4 shows hybrid automobile 19 having inverter and connection apparatus 20 in the trunk. Car 19 is shown parked in the garage of house 21 with hatch 22 open and apparatus 20 connected to pre-existing electric breaker box 23 with service conduit 24 of house 21 by cables 25 and 26.

FIG. 5 shows details of parts of FIG. 4. Means 20 carries outlet box means 27 having circuit breaker 27b and selector switch 27a and having three outlet receptacles, i.e. two 120 v. receptacles 28 and one 240 v. 1-phase receptacle 29, the latter being shown occupied and plugged into by cable 25 leading to socket 38 to mate with shrouded connector means 39 on breaker body 30 at the other end. Box 27 also carries ground jumper cable 26 with clamp 31. Breaker 30 also has switch handle 32 and screw contact means 33. Breaker 30 has bus prong sets 34 and 35 In addition, body 30 also has prongs 36 and 37. The prongs 36 and 37 are shown prepared to receive end socket 38 of cable 25 about to go into shroud 39 and around prong sets 36 and 37. Shroud 39 is shown cut away in FIG. 5.

FIG. 6 shows a three-rail-car embodiment of the invention on spur 41 having car-bumper 42. The Fig. shows coal-car 43 filled with coal 44 shown in the cutaway. Middle car 45 is a flatcar carrying hopper 46 feeding firebox 47 serving boiler 48 to operate steam turbine 49 to drive electrical generator 50. Structural means not shown carry conveyor means 51 shown partly cut away, the cutaway portion being denoted by outline 52; an alternative transit position of conveyor 51 is denoted by outline 53, directly above car 45. Cutaways of conveyor 51 and car 43 also show level belt conveyor 51a and sweeping bucket elevator 51b comprising conveyor 51. Tarp and sealing means 54 cover car 43. Caboose car 55 carries cherry-picker 56, transformer 57, switchgear 58, control-house 59 and bucket truck 60 all in travelling position. Cherry-picker 56 comprises main boom 61, telescoping boom 62, and insulator hanger cross-arms 63 and hook means 64. Transformer 57 and switch-gear 58 co-operate through cable means 65, 66, and 67 to provide suitable voltages as needed. Cable means 67 is spooled on spool means 68. Truck 60 has headache rack 69 and bucket 70

FIG. 7 shows the means of FIG. 6 deployed at another site and viewed along the axis of travel rather than broadside. FIG. 7 shows car 55 sitting alongside and clear of line 71, not on it, with car 55 carried by walking jack sets 72 clear of rail traffic on line 71. Cranes 56 and 60 are shown deployed to connect cable means 67 now partially unspooled from means 68 and hanging from insulators 63 in preparation for connecting into pre-existing transmission line 73. FIG. 7 also shows jack legs 75 of jacks 78 with footings 79 all operated by walking spars 76, i.e. 76a and 76b.

FIG. 8 is a plan of part of FIG. 7, showing walking jack apparatus 72 supporting rail car 55, shown only in outline. Each of the two four-footed pieces 72 comprises U-shaped frame 74 and powering and control means 75 therefor mounted thereupon. Each means 72 further carries one each sliding spar boom means numbered 76a and 76b respectively, shown in the FIGS. 7 and 8 with 76a to the left and 76b to the right. Each boom 76 has at each end thereof demountable jacks 78 with footings 79.

FIG. 9 shows flatbed semi-trailer 80 travelling down a road. Trailer 80 carries motor fueling and environmental protection apparatus 81 mounted on motor 82 to drive generator 83 having transformer and hookup apparatus 84. Trailer 80 has two folding articulated cranes 85 and 86 monted and folded crossways ath the rear and front respectively. Trailer 80 also carries belly-pad footing 87 carried high on links 88 centered below the width of trailer 80. Trailer 80 also carries two walking jack assemblies 89 standing astride means 82 and 83, held there for transport by rack means not shown. Spars 90 have jacks 91 with footings 92 at each end, similar to jacks 78 and footings 79 shown before.

FIG. 10 shows trailer 80 and means 81, 82, 83, and 84 thereof deployed at a site. The crane 85 has articulated boom 90 manipulating fuel line 91 and fuel hookup and spill-protection coupling 92. Crane 86 with boom 93 is carrying electrical line 94 from spool means 95 of electrical gear 84 preparing for connection. The footings 92 are shown held down by jacks 91 of sleeves 89 and spars 90 to serve foundations. Pad 87 is held down by links 88 and locked down partly by struts 95 and serves likewise as part of the foundation of trailer 80.

### DETAILED DESCRIPTION OF THE INVENTION

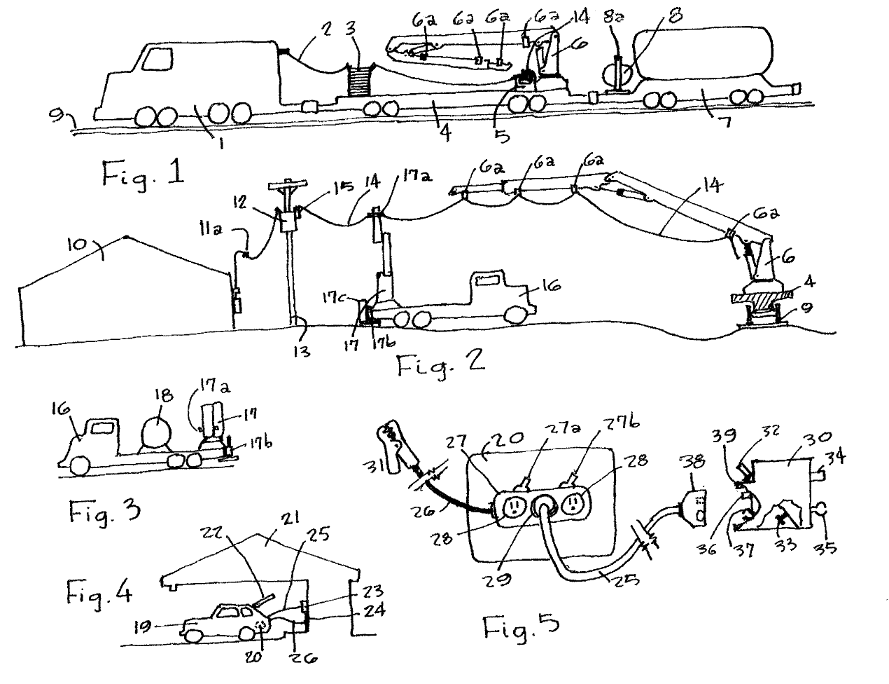

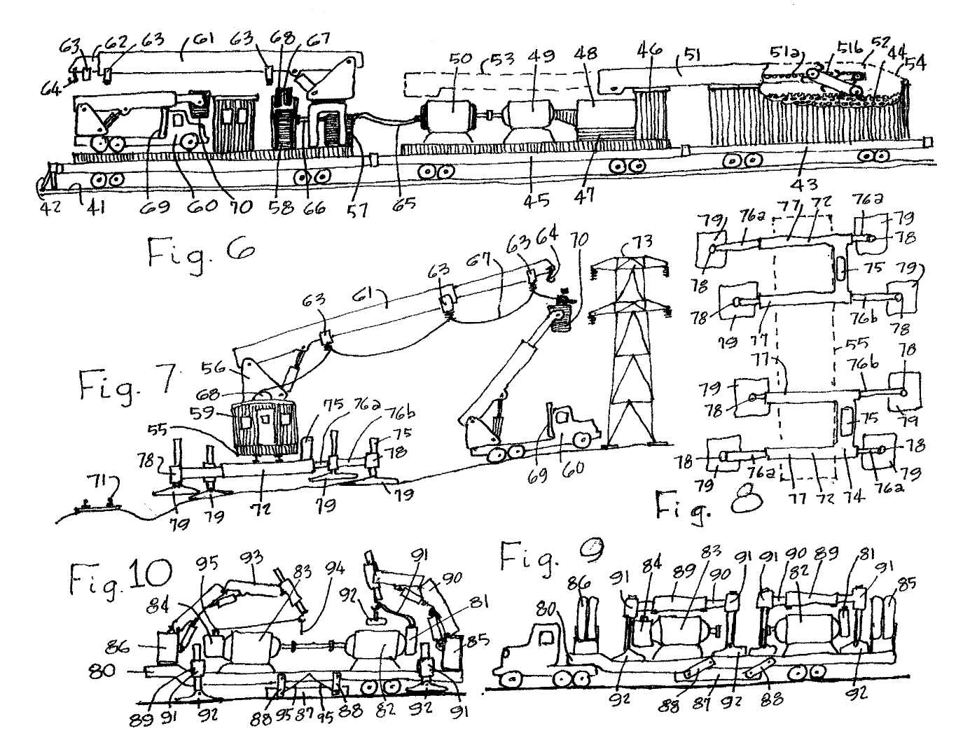

FIG. 1 shows diesel-electric locomotive 1 having removable tap means 2 connecting and tapping into the 480 v. 3-phase AC generator within locomotive 1, which said 1 is of the type wherein the diesel engine drives an AC generator, which in turn gives motivation to the locomotive wheels. Means 2 feeds the 480 v. AC to transformer-and-switch-gear hookup means 3 which is adapted to transform the power carried by means 2 selectively to conform to the demand at the emergency site to be served. Car 4 carries spool means 5 and knuckle-boom crane 6. Attached to and behind car 4 is car 7, car 7 being a diesel-fuel-carrying tank car carrying hose and pumping means 8, which was installed previously partly by use of crane 6 before leaving the rail yard from which the whole came, before which car 7 was simply an ordinary tank car . Means 8 is for refuelling tractor means 1 during operation of said tractor 1 at a site of emergency power service, if and as needed. Means 8 can be handled from car 7 onto a newly-arrived replacement for car 7 by jackup legs 8a on means 8 and other self-mobilizing power and control means thereon not shown.

FIG. 2 shows car 4 in end view and parked on track 9 at the site of emergency need, in deployment for emergency electrical service to building 10. It happens that building 10 and other buildings not shown commonly receive 240 v. 3-phase service through weatherheads 11 (called 11a in case of building 10, otherwise not shown) through pre-existing utility service transformer 12 on pre-existing pole 13. Since transformer 12 is a stepdown transformer receiving 480 v. and delivering 240 v., transformer means 3 is set as if at 1:1, i.e. putting out the same as it receives, although it is adapted to other ratios and connectedness for other emergency sites as needed. In this view, means 5 seen before, but not shown in this Fig. feeds cable 14 through emergency switch gear 15, set by the utility company on transformer 12 for this emergency, into the 480 v. primary side of transformer 12. Gear 15 of the invention can be set to receive power from the preexisting line or from cable means 14 as desired, but not from both at the same time, thereby enabling the safety, economy, and convenience of isolation of the regular and emergency power supplies from each other and rapid conversion from one the one source to the other. The means 5 feeds line to crane 6 which then carries said 14 on insulators 6a of crane 6 to safe connection to switch 15, and during power transmission by line 14, means 5 interlocks with the motive means of crane 6 so as to prevent dangerous motions thereof. Track 9 is too far from building 10 for for the crane 6 to suffice to carry the line 14 all of the way, so truck 16 having knuckle-boom crane serves to support line 14 over a part of the distance, using insulator arm 17a of crane 17 for the purpose. Outrigger footings 17b are down to stabilize truck 16, and portable concrete highway median casting 17c has been placed over footings 17b to further stabilize the whole.

FIG. 3 shows truck 16 just seen, which happens to be a hybrid diesel-electric truck, and which has crane 17 on the back for usual knuckle-boom uses, as well as the use shown in FIG. 2, where crane 17 of said truck 16 had been modified to adapt it to emergency-pole use of the invention by addition of insulators 17a. and by addition of ballast 17c to the usual outrigger footings 17b. Truck 16 is a hybrid vehicle whose generator produces DC, not AC like tractor 1; such DC powers not only the wheels, but may power various tools and implements as desired. In this case, as in FIG. 2, this DC powers the compact knuckle-boom crane 18. However, FIG. 3 shows inverter means 18 which was not present on truck 16 in FIG. 2. Inverter 18 has been added to convert truck 16 into an analogue of tractor 1 No detail is shown, since 16, 17 and 18 are analagous to 1, 6, and 3 of FIGS. 1 and 2, except that the whole runs on rubber and the power out of truck 16 is DC, so the conversion 17 is by inverter rather than transformer; so by reference to the foregoing FIGS. 1 and 2, and FIGS. 4 and 5 following, the whole emergency power plant of FIG. 3 may be easily be implemented by those skilled in the art. This shows the practice of an important benefit of the invention, that the elements of the invention are available for a variety of uses, and can be modified and remodified to reduce the first-cost penalty of the emergency power plants prior art.

FIG. 4 shows yet another hybrid vehicle, this time an automobile 19 having a gasoline engine driving a DC generator charging a bank of batteries, but having the added feature of inverter and connection apparatus 20 in the trunk. Car 19 is shown parked in the garage of house 21 with hatch 22 open and apparatus 20 connected to pre-existing electric breaker box 23 with service conduit 24 of house 21 by cables 25 and 26 respectively, and by means to appear in FIG. 5 FIG. 5 shows details of parts of FIG. 4. Means 20 carries outlet box means 27 having circuit breaker 27b and selector switch 27a and having three outlet receptacles similar to those found in most houses in America, i.e. two 120 v. receptacles 28 and one 240 v. 1-phase receptacle 29, the latter being shown occupied and plugged into by cable 25 leading to socket 38 to mate with shrouded connector means 39 on breaker body 30 at the other end. Box 27 also carries ground jumper cable 26 with clamp 31 for clamping onto ground means such as conduit 24 of FIG. 4, where cable 26 is shown to be so clamped. Means 30 is a 240 v. 1-phase circuit-breaker sufficiently resembling the circuit-breaker usually housed in breaker box 23 that means 30 can replace the said usual breaker, to provide the benefits of the invention to the owner of car 20 and of house 21, including quick installation and switching between utility-company service and emergency service. Breaker 30 also has switch handle 32 and screw contact means 33 below which receive the usual to-be-hot wires of the house wiring circuits in the usual way when the said substitution is made. Breaker 30 has bus prong sets 34 and 35 resembling those of the pre-existing breaker, except in respects to be explained. In addition to the apparently usual features switch 32, screw 33, and prong sets 34 and 35, body 30 also has prongs 36 and 37 in some correspondence to and alternative to prongs 34 and 35 respectively, i.e. they receive power from inverter means 20 when prong sets 34 and 35 do not serve to receive power. The prongs 36 and 37 receive it through cable 25 end socket 38 which goes into shroud 39 and around prong sets 36 and 37; shroud 39 is shown cut away in the FIG. 5. The body 30 contains sensors sensing not only electrical stress, but also mechanical stress in prongs 34, 35, 36, and 37, and contains logic and control means so that certain conditions are required to be met before certain actions can occur, to provide safety of operation. In particular,

no electrical transmission can occur through box 30 unless prong sets 34 and 35 are mechanically statically stressed as by being plugged into a breaker box,

no electrical transmission can occur through prongs 36 and 37 unless prongs 36 and 37 are also mechanically statically stressed as by being plugged into means 38,

prong set 35 will be made electrically inert and isolated by appearance of a voltage on any part of prong sets 36 or 37, and

the breaker will be thrown by any change in the above conditions, or by disappearance of pre-existing voltage from any of said prong sets, except that when service is from means 20, such service can continue during intermittency of voltage on prong sets 34 and 35.

The above just-said provides that switching from utility company service to inverter 20 service can only be accomplished with everything plugged in, and provides that no danger will appear to users if cable 25 is unplugged either intentionally or unintentionally. Other and usual interlocks are also part of means 30 and of means 27, according to the prior art.

The first 5 figures show hybrid self-propelled vehicles adapted to embody the invention. The next 5 figures show purpose-built embodiments.

FIG. 6 shows a three-rail-car embodiment of the invention newly arrived and parked on spur 41 having car-bumper 42 at the end. Said 3-car embodiment comprises replaceable and modular coal-car 43, an open-top rail car filled with coal 44 shown in the cutaway. Middle car 45 is a flatcar carrying hopper 46 feeding firebox 47 serving boiler 48 to operate steam turbine 49 to drive electrical generator 50. all disposed and co-operating by means well-known in the prior art. Structural means not shown carry conveyor means 51 shown partly cut away, the cut away portion being denoted by outline 52, said conveyor 51 having been carried in transit in the travelling position denoted by outline 53, directly above car 45. Conveyor 51 has just been relocated to position 52 in FIG. 6. Said cutaways of conveyor 51 and car 43 also show level belt conveyor 51a and sweeping bucket elevator 51b disposed as in the prior art to comprise conveyor 51; not shown, but present, are vacuum cleanup means of conveyor 51. Environmental protection means comprising tarp and sealing means 54 and other apparatus not shown but well-known in the art are included herein.

FIG. 6 also shows caboose car 55 which carries cherry-picker 56, transformer 57, switchgear 58, control-house 59 and bucket truck 60 all in travelling position, although by now cherry-picker 56 has been operated to set conveyor 51 to position 52 from position 53 and to help place environmental protection means 54 as said. Cherry-picker 56 comprises main boom 61, telescoping boom 62, and insulator hanger cross-arms 63 and hook means 64 for general hoisting tasks, such as setting conveyor 51 as said, and will be used to pick up bucket-truck 60 by its headache rack 69 and set it on the ground as needed and as follows. Transformer 57 and switchgear 58 are disposed to co-operate by well-known means and through cable means 65, 66, and 67 to provide suitable voltages as needed. Cable means 67 is spooled from spool means 68 as will be shown in FIG. 7. Truck 60 comprises headache rack 69 which comprises lifting adaptations for said handling by cherry-picker 56. Truck 60 also has adaptations not shown to serve as a car-puller for replacing car 3 by another such coal car as needed. Truck 60, being a bucket truck, is thereby adapted for electrical work to be shown.

FIG. 7 shows the means of FIG. 6 deployed at another site and viewed along the axis of travel rather than broadside; the cars have arrived on rail line 71 which is not a spur, but a traffic-carrying line. and the view FIG. 7 shows car 55 sitting alongside and clear of line 71, not on it, with car 55 carried by walking jack sets 72 to be shown further in FIG. 8. This offsetting allows line 71 to serve normal rail traffic. Cranes 56 and 60 are shown deployed to connect cable means 67 now partially unspooled from means 68 and hanging from insulators 63 in preparation for connecting into pre-existing transmission line 73 by means not shown, but comprising switching electrical tap means, to provide the benefits of the invention to loads along the line 73. Cherry-picker 56 is thus disposed to serve as a transmission-line pole requiring no site construction, in addition to being useful in usual cherry-picker ways. FIG. 7 also shows jack legs 75 of jacks 78 with footings 79 all operated by walking spars 76, i.e. 76a and 76b. The footings 79 of spars 76a are shown lifted up in preparation for shifting further out of the way of track 71, while the footings 79 of spars 76b are locked down and supporting the whole. For final founding, all eight footings 79 will be down and will thereby provide safe stable transmission.

FIG. 8 is a plan of part of FIG. 7, showing walking jack apparatus 72 supporting rail car 55, shown only in outline. Each of the two four-footed pieces 72 comprises U-shaped frame 74 and powering and control means 75 therefor mounted thereupon. Each means 72 further carries one each sliding spar boom means numbered 76a and 76b respectively, shown in the FIGS. 7 and 8 with 76a to the left and 76b to the right; of course, during walking the positions will alternate when booms 76 slide alternately through sleeves 77 to walk. Each boom 76 has at each end thereof demountable jacks 78 for urging footings 79 up and down for walking and for stable foundation after walking into position, all according to means well-known in the art. Not shown are detail of the pump means 75 or any part of structural racks and couplings on car 45 for carrying and mounting means 72 and components thereof since such are well-known in the art.

FIGS. 9 and 10 show a semi-trailer embodiment of the invention which parallels the rail-car embodiment of FIGS. 6, 7, and 8, just as FIG. 3 parallels FIGS. 1 and 2, and so FIGS. 9 and 10 will be elliptical, as was FIG. 3, since those skilled in the art will see the parallels and implement easily.

FIG. 9 shows flatbed semi-trailer 80 travelling down a road. Trailer 80 is analagous to cars 45 and 55 in that it carries corresponding elements, but is different in that all are on a single flatbed, the whole being smaller and for smaller electrical loads, and adapted to liquid fuel. Trailer 80 carries motor fueling and environmental protection apparatus 81 mounted on motor 82 to drive generator 83 having transformer and hookup apparatus 84. Trailer 80 has two folding articulated cranes 85 and 86 monted and folded crossways ath the rear and front respectively. Trailer 80 also carries belly-pad footing 87 carried high on links 88 centered below the width of trailer 80 for founding and walking as will be seen. Trailer 80 also carries two walking jack assemblies 89 standing astride means 82 and 83, held there for transport by rack means not shown. Assemblies 89 are analagous to means 72 except that the presence of belly means 87 makes only one sliding spar 90 needed for each frame, rather than two each spars 76a and 76b respectively per jacking assembly as before. Spars 90 have jacks 91 with footings 92 at each end, similar to jacks 78 and footings 79 shown before.

FIG. 10 shows trailer 80 and means thereof deployed at a site similar to the deployment of FIG. 2. The crane 85 has articulated boom manipulating fuel line 91 and fuel hookup and spill-protection coupling 92 to bring all into engagement with a fuel-tank truck not shown. Crane 86 with boom 93 is carrying electrical line 94 from spool means of electrical gear 84 preparing for connection to an electrical load at the site not shown. The footings 87 and 92 are shown all down, serving as foundations, having walked trailer 80 into the desired position. Cranes 85 and 86 were operated to lift frames 89 from the travelling position of FIG. 9 into locked engagement with trailer at and below each end of trailer 80 as shown in FIG. 10. Jacks 91 have operated to lift the weight of trailer 80 off of its wheels and front fifth wheel support and thereby enabled footing 87 to swing on links 88 into the lowered position of FIG. 10, and to be locked there by struts 95. Then jacks 91 operated to lift footings 92 while the whole was supported on pad 87, and the spars and jacks operated cyclically to walk the whole to the desired spot, as shown. The remainder of FIG. 10 is sufficiently parallel to the deployments of previous Figs. that implementation by those skilled in the art will easily follow.

The FIGS. 1 through 5 show adaptations of hybrid vehicles, i.e. thermal engines driving electric generators which normally serve to drive the wheels, but adapted in the Figs to emergency power service. The FIGS. 6 throught 10 show custom-built embodiments and show fuel-conveyance and walking jacking foundation means, variations of which may be adapted to the hybrid vehicles of FIGS. 1 through 5 by those skilledd in the art. Each hybrid-vehicle embodiment employs a hybrid vehicle whose envisioned purpose was transportation, not stationary use, with ancillary power-supply a secondary consideration. Use of vehicles for stationary power provides great savings over emergency site-built power plants in that the motor-generator costs of the emergency power plant are largely unrecoverable if need goes away, but the hybrid vehicle is hardly diminished in value by short-term use as shown.

Some hybrid vehicles known in the art employ the heat engine as a direct motive means as well as using the generated electricity to motivate the wheels. Some produce AC with the AC then being used to produce DC to drive the wheels. Some have large battery arrays and some have few and small batteries, and some travel on battery power alone at times. For the purposes of the invention, these are equivalent.

The matter of scale arises wherein a quantitive difference becomes, at some scale, a qualitative difference. For example, in an old car without such interlocks as are now commonplace, it was possible to move the car a distance by engaging the clutch and pressing the starter button; sometimes mechanics would do this when the engine was disabled or overheated. In the sense of countable identifiable elements, the said old car is a hybrid vehicle having a heat engine driving a generator to charge a battery, and the car was motivated for a time by an electric motor (the starter); however, such literal readings do not make the car a hybrid vehicle in a reasonable sense, partly because the intent and recommendations of the manufacturers would discourage such use. Similarly, stationary power-plant use of the car can be discovered in the playing of the radio with the car doors wide open at a picnic, with or without the engine left running, or the use of headlights for emergency illumination by an ambulance crew at a wreck-site on a highway. Likewise, portable generators usually used by construction workers provide stationary and perhaps emergency power at a site, maybe to operate a refrigerator or a respirator; however, such use involves trailing and/or draping of perhaps orange extension cords around the site; such practices are restricted in some jurisdictions, and are inconvenient and a little hazardous as a matter of course. All of these readings of the prior art rely on literal logic which denies ordinary logic which recognizes that a change of scale sometimes embodies a change of kind; i.e., the foregoing literal equivalents are unequivalent; equivalents are much the same, but the said literal so-called equivalents are not much the same.

FIG. 5 shows the outlet box 27 with its three-position switch 27a, which when centered is off, and when to the right, as shown, disconnects the 110 v. outlets 28 and connects or empowers only the center 240 v. 1-phase outlet 29 into which cord 25 is plugged. When switch 27a is to the left it energizes only the now-empty 110 v outlets, each with one half of the 240 v. deliverable to outlet 29, i.e. the output of inverter 20 is always 240 v 1-phase. Also, in FIG. 5, breaker body 30 is adapted to use in box 23 of FIG. 4, which has no rain cover, being in the garage of house 21. This design is the service entry means of the invention, and has the advantage that many jurisdictions allow homeowners to change their own circuit breakers, and many howmowners feel comfortable doing so. In any case, even if an electrician-contractor or power-company worker installs the means 20, the installation can be a one-time thing, since it is safely repeatedly switchably reconnectable to the car 19 through means 27.

Many variations of the means of FIG. 5 may be provided for various embodiments of the invention. A first obvious variation is a 120 v 1-phase variation to be used in the sockets 27 and plugged into a box such as box 23, either alone or in pairs. A second obvious variation is the provision of a variation for a box with a rain-cover. Most such boxes are surface-mounted with knockout plugs accessible, so a variation of body 20 wherein screw-terminals connect to a rainproof electrical coupling, the whole comprising a rain-proof equivalent to body 20, will be easily implemented. A similar rain-proof access to the means 20 or modification of means 20 for outdoor use are likewise easy to envision. Analagous means are easily envisioned, e.g. in means such as means 15 of FIG. 2. Many variations of such service-entry devices will be needed and provided by those skilled in the art, ranging all the way from simple double-throw switches with some circuit-protection and rain-protection up to uninterruptible power-supply-type couplings of means such as 15 to means such as locomotive 1 for automatic changeover in a matter of seconds. These variants on the service-entry means of the invention are generally equivalent and will be well-understood and easly provided by those skilled in the art.

Another variation of the invention which may be illustrated by reference to FIGS. 4 and 5, but which differs substantially therefrom, is the embodiment wherein means equivalent to means 20 (call it means T) are not carried on the hybrid vehicle, but are more or less permanently installed on the floor or wall beside the breaker box 23 equivalent. In such an embodiment means T receive the usual DC power from a DC cord from the hybrid vehicle; said vehicle would only be altered to the extent of providing safe plug-in means, if altered at all. The rail equivalent would comprise an inverter in the building and a DC service entry to the building. These embodiments would be especially valuable in case of medical need, for example at a hospital in addition to the ubiquitous hospital emergency motor-generator sets, or at a house with an invalid resident with urgent need for power. Notice that high power could thus be made avaliable to a hospital, i.e. thousands of horsepower or many megawatts would be available from one or more locomotives.

Concerning the self-erecting pole means, the Figs. and disclosure show knuckle-boom cranes or cherry-pickers of the prior art adapted by insulation, transport, and interlocking means to service of the invention. Envisioned is a plural array of such adapted truck-mounted boom cranes for carrying power over a distance, for example, across a street, waterway, or small building, in cases where there is a good distance between space for the invention and the demand. Additionally, knuckle-booms and cherry-pickers are valuable for such service, since, when not in service as power-transmission devices, they are quite useful and marketable for other service, just as the hybrid vehicles are, and give similar recoverability of investment. However, purpose-built other mobile and self-founding pole types will be seen to be equivalent for transmission-line service of the invention. One such type might use the familiar portable concrete traffic barriers which are used as temporary guardrails in highway construction as counterweights or foundations for such poles as a means of avoiding permanent construction according to the intent of the invention. Notice that such barriers also have the feature of high value recovery on completion of service, just as the cherry-pickers and locomotives are valuable elsewhere and for other purposes.

Note that the invention envisions a turbine-electric or steam-electric equivalent of the hybrid vehicles, and also envisions coal, fuel-cell, gas, liquefied gas, or vegetable-oil fueled eqiivalents of the diesel and gasoline fuels as equivalent for the purposes here. Further envisioned here are equivalence of simple pad footings and crawler-tracked footings, said tracked footings being powered for lateral motion or not powered, e.g. being actuated by external towing means into place for founding. Another equivalent walking foundation means is the straddle truck, either with crawler tracks or with wheels. Straddle trucks could be made to lift a locomotive off of the railroad and hold the locomotive founded near a transmission-line or service entry which could not otherwise be approached without obstructing rail traffic. So displacing the locomotive, thus making it a stationary engine, would reduce crew size requirements.

I claim:

1. A mobile power plant for supplying emergency electrical power to buildings comprising
a) a hybrid motor-generator vehicle adapted for conversion to stationary power supply service by fixed-site operation of the said motor-generator means,
b) an electrical service entry means for switchably connecting pre-existing demand back and forth between usual site power supply and this emergency plant, said entry comprising only minor site construction which may or may not require permitting, depending on jurisdiction, and
c) pre-engineered and pre-qualified power adaptation and transmission means freed by such pre-engineering and pre-qualification of certain requirements for site construction and associated delays of engineering plan preparation, submission, review, hearing, and/or permitting.

2. The plant of claim 1 comprising
d) pre-engineered and pre-qualified fuel receipt and conveyance means for environmentally correct mounting and fueling of said means a during power supply by said plant, and wherein said fueling is from fuel cars in the train of said mobile plant.

3. Claim 1 wherein said hybrid vehicle is a diesel-electric railway locomotive,

4. Claim 1 wherein said hybrid vehicle is a diesel-electric automobile or truck.

5. Claim 1 wherein said means c comprises an inverter

6. Claim 1 wherein said means c comprises a transformer.

7. Claim 1 wherein said means c comprises a self-erecting transmission-line pole means founded on or with said means a or b of said plant to carry said emergency power.

8. Claim 7 comprising a second self-propelled and self-erecting pole means independent of the first-said pole means.

9. Claim 7 wherein said pole means comprises automatic control-system interlock to inhibit motion of said pole means during said emergency powering.

10. Claim 1 wherein said means b comprises automatic control-system switching between said emergency powering and normal and usual power supply according to sensors therein sensing demand and supply.

11. Claim 1 wherein said means b comprises a circuit-breaker-substitute body for placement in the space of a pre-existing circuit-breaker and comprising manual switching between said means c and the usual normal power supply.

12. Claim 1 wherein said means c comprises an inverter and said means b comprises a circuit-breaker.

13. Permanent provision of emergency conversion of the motive electric power of a hybrid vehicle to serve a building comprising
a) means on said vehicle to tap into said motive power to carry said power out, and
b) service entry and conversion means installed on or about said building to receive said motive power from said tap to convert said motive power to the usual type of AC electrical service in the said building.

14. For emergency transmission of electrical power across a space, a vehicle with a self-erecting transmission-line pole thereon and having self-founding jack means and ballast means for stabilizing said pole during transmission as said, said self-erection for enabling quick commencement of said transmission without permanent construction.

15. Claim 14 wherein said pole means is a portable hydraulic crane of the prior art adapted to stationary said transmission use by insulator means on the boom thereof and wherein said crane is adapted to shift back and forth between said emergency transmission use and said prior art use.

16. Claim 14 wherein said ballast comprises two parts, i.e.
a) the weight of said vehicle, and
b) a dead weight portable separately from said vehicle.

17. Claim 14 wherein said self-erecting means has interlock means prohibiting said self-erection when and while said transmission-line is energized.

18. A portable emergency electrical power plant comprising
a) self-carried and self-installing walking jacking foundation footing means and
b) self-carried and self-installing transmission-line boom means for carrying said electrical service at least part way to pre-existing onshore demand.

19. Claim 18 comprising
c) self-carried and self-installing means for founding and receiving fuel carrier and storage tank cars to serve as fuel tanks for the said electrical power whicle supplying said power,
wherein a, b, and/or c above enable said plant
w) to go into service without permanent site construction permitting,
x) to go into service without the delay of permanent construction,
y) to go into service without the obstruction of public ways, and/or
z) to go into and out of service without site demolition or reconstruction. wherein.

20. Claim 18 wherein said plant comprises a marine vessel and wherein said foundation is for safely stabilizing said vessel without infrastructure near an onshore demand and said transmission line boom means comprises a pole truck held by outrigger jacking footings for safe transmission of power from said plant to said demand.
